(19) United States
(12) Patent Application Publication
(10) Pub. No.: US 2016/0321229 A1
(43) Pub. Date: Nov. 3, 2016

(54) TECHNIQUE FOR CLIPPING AND AGGREGATING CONTENT ITEMS

(71) Applicant: LinkedIn Corporation, Mountain View, CA (US)

(72) Inventors: Alexis B. Baird, San Francisco, CA (US); Grace B. Livingston, San Francisco, CA (US); Caroline Gaffney, Mountain View, CA (US); Jess D. Venticinque, San Francisco, CA (US); James Dixon, Mountain View, CA (US)

(73) Assignee: LinkedIn Corporation, Mountain View, CA (US)

(21) Appl. No.: 14/701,294

(22) Filed: Apr. 30, 2015

(51) Int. Cl. G06F 17/24; G06F 3/0481; G06F 17/27

(52) U.S. Cl. CPC G06F 17/241; G06F 17/2705; G06F 3/04817

(57) ABSTRACT

In order to facilitate access to and exchange of a given content item in a sequential set of content items (such as a slide in a presentation or a frame in a video), a system may create a clipped-content identifier in response to a clip selection of the content item by a user. This clipped-content identifier may include a pointer to a location in the system that stores the content item in the sequential set of content items, and metadata associated with the content item. Subsequently, the system may present a clipped-content summary document to the user, which allows the user to download, edit, share, and aggregate one or more clip selections in sequential sets of content items.

### BACKGROUND

1. Field

The described embodiments relate to techniques for facilitating access to content items. More specifically, described embodiments relate to techniques for facilitating access to content items in a sequential set of content items.

2. Related Art

The popularity of electronic devices and networked communication has resulted in a significant increase in interactions among individuals. For example, individuals regularly exchange presentations, video and, more generally, content with each other using these systems.

However, the large number of messages exchanged and the increasing size of the content is making it more difficult for individuals to use the content. In particular, it can be difficult for an individual to access specific content in a long presentation or video. Similarly, it is often cumbersome and time-consuming for an individual to share a long presentation or video. Consequently, existing approaches for communicating such information may be inadequate, which is frustrating to many individuals.

### BRIEF DESCRIPTION OF THE FIGURES

FIG. 1 is a block diagram illustrating a system used to present a clipped-content summary document in accordance with an embodiment of the present disclosure.

FIG. 2 is a flow chart illustrating a method for providing a clipped-content summary document in accordance with an embodiment of the present disclosure.

FIG. 3 illustrates communication between the electronic devices of FIG. 1 in accordance with an embodiment of the present disclosure.

FIG. 4 is a drawing illustrating a user interface associated with a sequential set of content items in accordance with an embodiment of the present disclosure.

FIG. 5 is a drawing illustrating a clipped-content summary document in accordance with an embodiment of the present disclosure.

FIG. 6 is a block diagram illustrating a computer system that performs the method of FIGS. 2 and 3 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to facilitate access to and exchange of a particular content item in a sequential set of content items (such as a slide in a presentation or a frame in a video), a system may create a clipped-content identifier in response to a clip selection of the content item by a user. This clipped-content identifier may include a pointer to a location in the system that stores the content item in the sequential set of content items and metadata associated with the content item. Subsequently, the system may present a clipped-content summary document to the user, which allows the user to download, edit, share and aggregate one or more clip selections in sequential sets of content items.

In this way, the clipped-content identifier may allow the user to readily and repeatedly access the content item and/or to share the content item without extracting or otherwise separating the content item from the sequential set of content items. This flexibility may increase user interaction and engagement with the system, as well as engagement with a social network or another service that facilitates interaction among the users (including publishing of the sequential sets of content items, and creation and maintenance of professional and/or personal relationships). Consequently, this content-management technique may increase user satisfaction with the system and/or the social network. Therefore, the content-management technique may increase the value of the system and/or the social network.

In the discussion that follows, an individual or a user may be a person (for example, an existing user of the social network or a new user of the social network). Also, or instead, the content-management technique may be used by an organization, a business, and/or a government agency. Furthermore, a ‘business’ should be understood to include for-profit corporations, non-profit corporations, groups (or cohorts) of individuals, sole proprietorships, government agencies, partnerships, etc.

Furthermore, as an illustration, in the discussion that follows the content item includes a slide, and the sequential set of content items includes a presentation. However, the content-management technique may be used with a wide variety of types of information, such as: a frame in a video, an audio frame in an audio file, a page in a document, graphical content in a set of graphs, etc.

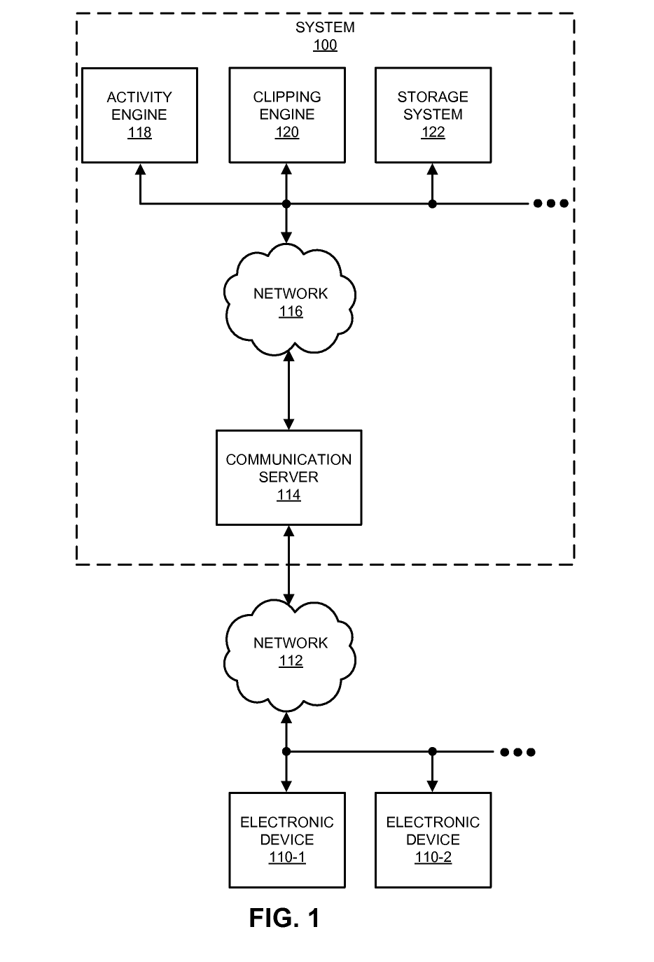

We now describe embodiments of the system and its use. FIG. 1 presents a block diagram illustrating a system 100 that performs the content-management technique. In this system, users of electronic devices 110 may use a software product, such as instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

Using one of electronic devices 110 (such as electronic device 110-1) as an illustrative example, a user of electronic device 110-1 may use the software application to interact with other users in a social network (and, more generally, a network of users), such as a professional social network, which facilitates interactions among the users. Note that each of the users of the software application may have an associated user profile that includes personal and professional characteristics and experiences, which are sometimes collectively referred to as ‘attributes’ or ‘characteristics.’ For example, a user profile may include: demographic information (such as age and gender), geographic location, work industry for a current employer, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections.

In particular, when using the software application, the users may post content or data items in the social network (which are sometimes referred to as ‘user posts’), such as: text, pictures, video, documents or files, presentations, etc. In addition, the users may post comments on other users' posts and/or about other users (such as endorsing the skill of another user in a particular area or topic). For example, a user may indicate that they like a user post or may provide feedback about the user post (sometimes referred to as a ‘tag’ or an ‘annotation’). In general, user posts and/or comments may include: verbal, written, and/or recorded information. Note that the user posts or comments may be communicated to other users via the software application that executes in the environment of electronic devices 110. Moreover, the users providing the posts may include so-called ‘influencers,’ who interact with multiple other users in the social network and may be represented in the social graph by nodes having multiple edges.

Over time, via network 116, an activity engine 118 in system 100 may aggregate the user posts, the associated comments and, more generally, the user interactions with each other in the social network. Then, activity engine 118 may store the aggregated information in a data structure, which is stored in a computer-readable memory, such as storage system 122 that may encompass multiple devices, i.e., a large-scale storage system.

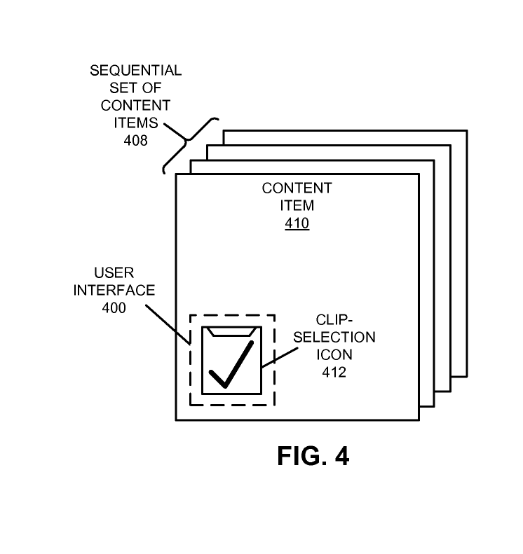

Subsequently, a user of electronic device 110-1 may use the software application to access posted content, such as presentations. In particular, and as described further below with reference to FIG. 4, using a clip-selection user interface, the user may select (or ‘clip’) a specific (or single or particular) content item (such as a slide) in a sequential set of content items (such as a presentation). Then, the user may activate a clip-selection icon in the clip-selection user interface. Information specifying this clip selection may be provided from electronic device 110-1 to system 100 via network 112. Based on the clip selection, clipping engine 120 may create a clipped-content identifier for the selected content item, which includes a pointer to the content item in the sequential set of content items and metadata associated with the content item.

For example, the pointer may specify a storage location in storage system 122 where the content item is stored. Moreover, the metadata may include: a name of the sequential set of content items, one or more annotations associated with the content item, and/or an author of the sequential set of content items (as specified by the author's name or an identifier of the author). In some embodiments, the clipped-content identifier includes one or more keywords extracted from the content item. Note that the clipped-content identifier may include a timestamp associated with the chip selection, such as a time when the chip-selection icon was activated by the user.

Over time, the user may view multiple sequential sets of content items, and may create multiple clipped-content identifiers for multiple selected or clipped content items in the sequential sets of content items. Then, using the software application, the user of electronic device 110-1 may use the clipped-content identifiers to access, modify and/or aggregate the clipped content without requiring that the content be extracted from the sequential sets of content items.

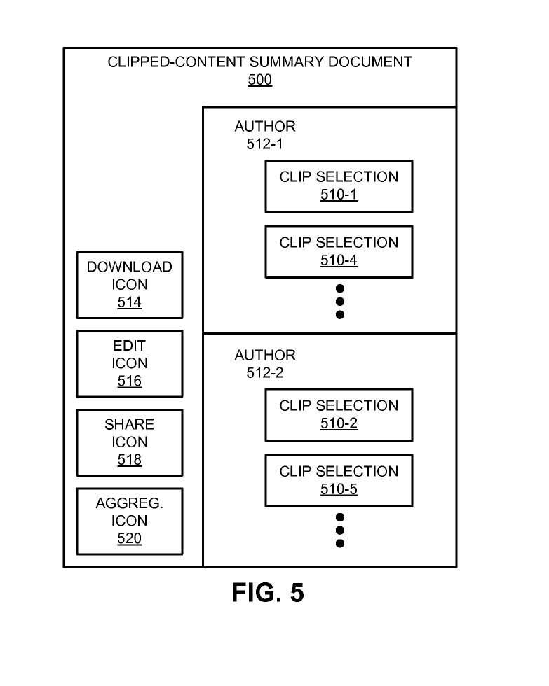

For example, clipping engine 120 may provide a clipped-content summary document (such as a web page) of clip selections to a location of electronic device 110-1 in network 112 (such as an IP address of electronic device 110-1). As described further below with reference to FIG. 5, the clip selections in the clipped-content summary document may be organized by or according to: metadata associated with the clip selections, names of the sequential set of content items that include the clip selections, authors of the sequential set of content items that include the clip selections, timestamps associated with the clip selections, and/or one or more annotations associated with the content item. In some embodiments, the clip selections are ranked based on how many different users in the social network have clipped the corresponding content items.

Thus, using the clipped-content summary document, the user may be able to repeatedly view clip selections associated with a particular sequential set of content items, a particular author, annotations in the clip selections (i.e., the content items), keywords in the clip selections, etc. For example, if the user activates an icon in the clipped-content summary document associated with a particular clip selection, the pointer in the associated clipped-content identifier may allow the user to rapidly (and repeatedly or as needed) access the corresponding content item in one of the sequential sets of content items.

In addition, by selectively activating icons in the clipped-content summary document, the user may: download one or more clip selections to electronic device 110-1, edit annotations associated with one or more clip selections, share clip selections with other users, aggregate clip selections into a new sequential set of content items (thus, the user may be able to ‘publish’ their own sequential sets of content items in the social network), and/or take other action.

In these ways, the content-management technique may allow users to flexibly access, edit, aggregate and exchange content items that are included in sequential sets of content items. Moreover, for each of these operations, the clipped-content identifiers (and, in particular, the pointers) may facilitate the operations with: reduced cost, delay and complexity. Consequently, the content-management technique may improve the user experience with system 100 and the social network. This may result in increased engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

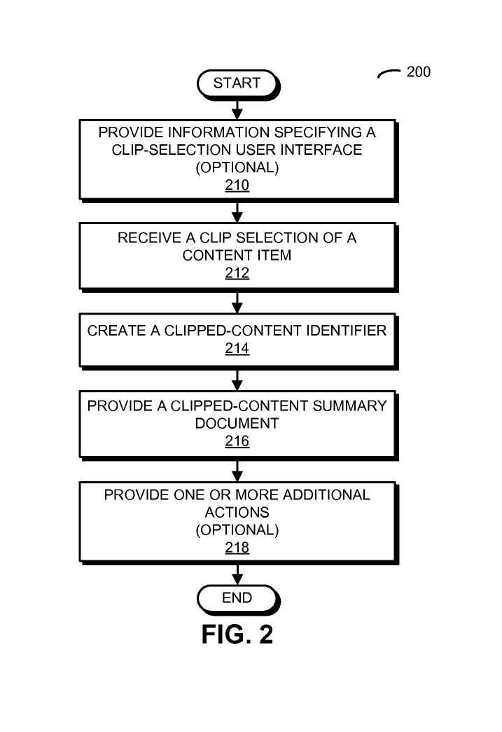

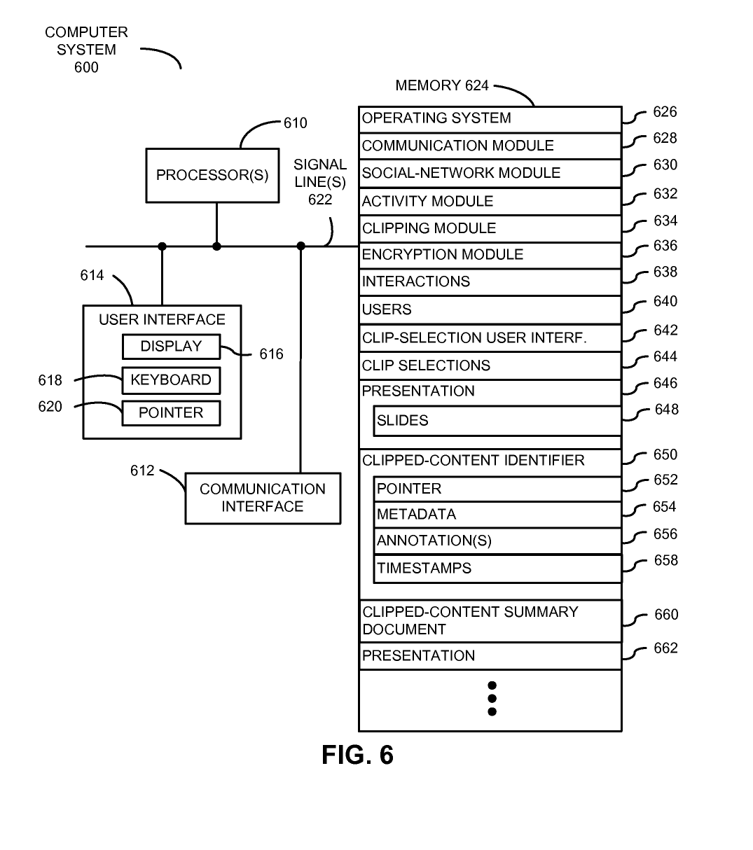

We now describe embodiments of the content-management technique. FIG. 2 presents a flow chart illustrating a method 200 for providing a clipped-content summary document, which may be performed by a computer system (such as system 100 in FIG. 1 or computer system 600 in FIG. 6). During operation, the computer system receives a clip selection of a content item (operation 212) in a sequential set of content items. Then, in response to receiving the clip selection, the computer system creates the clipped-content identifier (operation 214) that includes a pointer to the content item in the sequential set of content items (such as: a slide in a presentation, and a frame in a video, etc.) and metadata associated with the content item. For example, the pointer may specify a storage location in the computer system where the content item is stored. Moreover, the metadata may include: a name of the sequential set of content items, an author of the sequential set of content items, and/or one or more annotations associated with the content item.

Furthermore, the computer system may provide a clipped-content summary document (operation 216) of clip selections. The clip selections in the clipped-content summary document may be organized in various ways such as: information in metadata associated with the clip selections, names of the sequential set of content items that include the clip selections, authors of the sequential set of content items that include the clip selections, annotations associated with the clip selections, one or more keywords in the content items, timestamps associated with the clip selections, etc.

In some embodiments, the computer system optionally provides information specifying a clip-selection user interface (operation 210) for display on an electronic device associated with a user. In these embodiments, the clip selection is associated with user activation of a clip-selection icon in the clip-selection user interface.

Additionally, based on an instruction or command received when a user activates an icon in a user interface associated with the clipped-content summary document, the computer system may optionally perform one or more additional actions (operation 218).

For example, the user may activate a download icon in the clipped-content summary document. After receiving activation information for the download icon (which specifies a particular clip selection), the computer system may access the content item associated with the clip selection based on a pointer to the content item, and the computer system may provide the content item to a location in the network (such as to an electronic device of the user).

Alternatively or additionally, the user may activate an editing icon in the clipped-content summary document. After receiving activation information for the editing icon (which specifies a clip selection), the computer system may provide an annotation modification feature (such as a user-interface feature with a virtual keypad and a text box that displays entered text) in the clipped-content summary document that allows a user to modify an annotation corresponding to a content item associated with the clip selection. Moreover, after receiving a modification to the annotation corresponding to the content item, the computer system may change the annotation in metadata associated with the content item.

Furthermore, or instead, the user may activate a sharing icon in the clipped-content summary document. After receiving activation information for the sharing icon (which specifies a particular clip selection), the computer system may provide a sharing-information feature in the clipped-content summary document that allows a user to share the clip selection. For example, the sharing-information feature may include a user-interface feature (such as a user-interface feature with a virtual keypad and a text box that displays entered text) that allows the user to provide contact information of another user, such as: an email address, a telephone number or a location in the network of the other user (such as an IP address of the other user). After receiving the contact information, the computer system may provide, based on the contact information, a pointer and metadata of the clip selection to the other user (e.g., the computer system may provide an email or a text message with an embedded link to the clip selection).

In some embodiments, the user may activate an aggregation icon in the clipped-content summary document. After receiving activation information for the aggregation icon (which specifies a particular clip selection), the computer system may provide an aggregation feature in the clipped-content summary document that allows a user to specify at least a subset of the clip selections. For example, the aggregation feature may include a user-interface feature that allows the user to select at least the subset of the clip selections. Then, the computer system may aggregate pointers and metadata for at least the subset of the clip selection into another sequential set of content items, and the computer system may provide another pointer and other metadata for the other sequential set of content items in the clipped-content summary document (i.e., the computer system may create another clipped-content identifier for the other sequential set of content items).

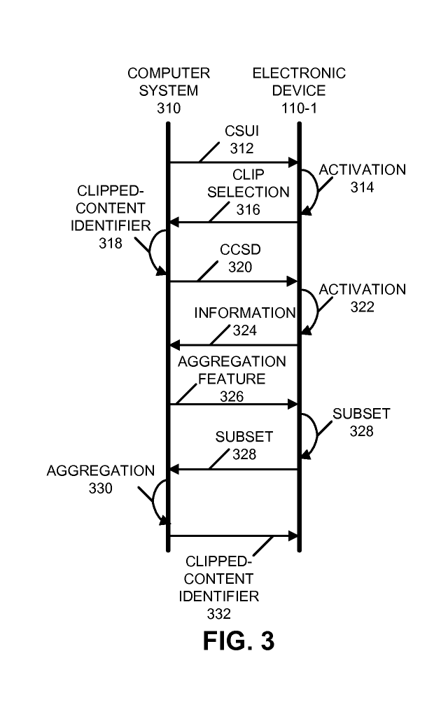

In an exemplary embodiment, method 201 is implemented using one or more electronic devices and at least one server (and, more generally, a computer system), which communicate through a network, such as a cellular-telephone network and/or the Internet (e.g., using a client-server architecture). This is illustrated in FIG. 3. During operation of this method, computer system 310 (which may implement some or all of the functionality of system 100 in FIG. 1) may provide information specifying a clip-selection user interface (CSUI) 312 to electronic device 110-1, which displays clip-selection user interface 312. If a user activates 314 a clip-selection icon in clip-selection user interface 312, electronic device 110-1 may provide a clip selection 316 of a content item in a sequential set of content items to computer system 310. After receiving clip selection 316, computer system 310 creates a clipped-content identifier 318 that includes a pointer to the content item in the sequential set of content items and metadata associated with the content item.

Subsequently, computer system 310 may provide information specifying a clipped-content summary document (CCSD) 320 of clip selections to electronic device 110-1, which is then displayed on electronic device 110-1. Using clipped-content summary document 320, the user can: view the clip selections, download the clip selections, edit one or more annotations associated with the clip selections, share the clip selections with other users, and/or aggregate clip selections into new sequential sets of content items.

For example, the user may activate 322 an aggregation icon in clipped-content summary document 320, and information 324 specifying this activation is provided to computer system 310. After receiving the activation information, computer system 310 may provide an aggregation feature 326 in clipped-content summary document 320, which is presented to the user on electronic device 110-1 and which allows the user to specify at least a subset 328 of the clip selections. Then, electronic device 110-1 provides information specifying subset 328 to computer system 310. Based on this information, computer system 310 may aggregate 330 pointers and metadata for at least subset 328 of the clip selection into another sequential set of content items. Next, computer system 310 may provide another clipped-content identifier 332 for the other sequential set of content items to electronic device 110-1, which is then presented to the user in clipped-content summary document 320.

In some embodiments of method 200 (FIGS. 2 and 3), there may be additional or fewer operations. Moreover, the order of the operations may be changed, and/or two or more operations may be combined into a single operation. For example, in some embodiments a user may use clip selections aggregated in the clipped-content summary document (or a clipboard or a notebook) to subsequently create a new presentation.

We now describe embodiments of the user interfaces. FIG. 4 presents a drawing illustrating a user interface 400 associated with a sequential set of content items 408. In particular, user interface 400 is an example of a clip-selection user interface that is displayed or overlaid on an individual content item 410 in sequential set of content items 408, such as one slide in a slide presentation that the user is viewing. By clicking on or activating clip-selection icon 412 in user interface 400, the user can generate a clipped-content identifier for content item 410.

As shown in FIG. 4, after activating clip-selection icon 412, a visual (and, more generally, sensory) information (such as a check mark) may be displayed to indicate that a clip selection has been generated for content item 410. Alternatively or additionally, clip-selection icon 412 may provide feedback about how many slides in the presentation the user has clipped. For example, clip-selection icon 412 may display the number of slides the user clipped in the presentation.

FIG. 5 presents a drawing illustrating a clipped-content summary document 500. In this user interface, clip selections 510 are displayed according to authors 512 of sequential sets of content items. However, in other embodiments metadata, timestamps, keywords, one or more annotations, the number of users that clipped the same clip selection, and/or other parameters are used to organize clip selections 510.

If the user clicks on or activates one of clip selections 510, the pointer in the associated clipped-content identifier allows the user to readily access the associated content item. Furthermore, clipped-content summary document 500 may include additional icons, such as: a download icon 514, an edit icon 516, a share icon 518 and/or an aggregation icon 520. The user can select these icons to, respectively: download one or more of clip selections 510, edit an annotation associated with one of clip selections 510, share one of clip selections 510 with one or more other users, and/or aggregate the content items associated with two or more clip selections 510 into a new sequential set of content items. Note that the content items can be aggregated into the new sequential set of content items without extracting the content items from their original sequential sets of content items.

In an exemplary embodiment, the content-management technique allows users to mark (which is sometimes referred to as ‘clip,’ ‘bookmark,’ ‘highlight,’ ‘pin,’ etc.) important elements of or relevant content in a presentation (or another sequential set of content) in order for them to access the content in the future, without requiring the user to extract or remove the content items from the presentation. (Thus, in contrast with existing approaches, the content-management technique does not require the users to download or bookmark the entire presentation.) The content-management technique may provide a tool that allows the users to collect and organize the content items so that users can use them when and how they need them. In addition, the pointers in the clipped-content identifiers provide a way for the users to share their clips with others and to dynamically aggregate the content items into new presentations. For example, using a pointer, a user may access (e.g., navigate) a particular content item, such as a particular slide in a presentation.

When using a clip-selection user interface, a user may view slides as they navigate through a presentation. One each slide there may be an option to clip (such as clip-selection icon). If the user has never clipped a slide before, but likes, comments, shares or downloads a presentation, the clip-selection user interface may indicate an invitation to coping: Finding inspiration? Now you can save individual slides from a presentation by clipping them. You can view and organize these slides later. If the user finds an important slide that they wish to clip, the user can click on or activate the clip-selection icon.

Alternatively, if the user is logged in to the social network, a confirmation may be displayed indicating that the user ‘clipped’ the slide and/or a user-clip count from that presentation may be incremented. In addition, the clip-selection user interface may display a link to further manage the clip, such as a link to the clipped-content summary document. If the user declines to further manage the clip, the user may be allowed to continue browsing slides.

The system may save a clip with default data, such as: a notebook (or clipboard) where clips are stored or a name of the presentation (which, if the user has already clipped other slides in the same presentation, the clip would be saved to that existing notebook), any tags or annotations already associated with the presentation, and/or the user identifier.

The first time a user clips a slide, the clip-selection user interface may display a message such as: You've clipped slide <slide number> from <presentation name>. You can clip and save slides that you think are important. You can view your clipped slides at any time.

If the user is not logged in, the clip-selection user interface may display a login dialogue with a suitable heading, such as: Login to clip slides.

Note that the clip-selection user interface may provide functionality (i.e., while the user is viewing a slide), such as: clip a slide, unclip slide, go to manage clips page (i.e., the clipped-content summary document), see the number of times people have clipped a given slide, see in the presentation where the user has clipped slides, move (or copy) the current clipped slide to a different notebook, add/modify notes, tags or annotations on the current clipped slide.

When the user first clips a slide from a given presentation, the clipped-content identifier for the slide may be added to a default notebook (such as, clips from <presentation name>). The user can then change the name of the notebook where the slide has been saved. If the user changes the name of the notebook, the next clip from that same presentation will go into the new notebook name by default. In some embodiments, the user or the author of the presentation receives a reward for clipping.

Using the clipped-content summary document, the user can access their clips and notebooks via drop-down navigation options from their profile under ‘My clips,’ from a ‘View my clips’ link on the clip-selection user interface and/or from their own profile in a section titled ‘<user name's> clips.’ A clipped-content summary document may display all the clips a user has made organized, which may be organized in any desired manner, such as: by their source (i.e., the presentation from which they were clipped), annotations, authors, when they were clipped (i.e., timestamps), etc. The user may use the clipped-content summary document to: view clips (by activating links to associated pointers), group or aggregate clips, edit clips (such as adding, deleting or modifying tags), download clips, delete clips, move clips to different notebooks, and/or share clips.

The clipped-content identifier for a given clip (which is sometimes referred to as a ‘clip selection’), such as a slide, may include: the identifier for the presentation (or other document) from which the given clip was clipped, a user identifier, a slide identifier, the notebook identifier, the title, a description, privacy options (such as public or not shared with others), one or more tags or annotations, and/or a timestamp. When the user is using one of the user interfaces, the system may track: impressions of the slides, activations of the clip-selection icon, impressions of the clips, user interest in managing a clip, clips that are downloaded, changes to annotations, etc.

We now describe embodiments of a computer system for performing the content-management technique and its use. FIG. 6 presents a block diagram illustrating a computer system 600 that performs method 200 (FIGS. 2 and 3), such as system 100 in FIG. 1 or computer system 310 in FIG. 3. Computer system 600 includes one or more processing units or processors 610 (which are sometimes referred to as ‘processing modules’), a communication interface 612, a user interface 614, memory 624, and one or more signal lines 622 coupling these components together. Note that the one or more processors 610 may support parallel processing and/or multi-threaded operation, the communication interface 612 may have a persistent communication connection, and the one or more signal lines 622 may constitute a communication bus. Moreover, the user interface 614 may include: a display 616 (such as a touchscreen), a keyboard 618, and/or a pointer 620 (such as a mouse).

Memory 624 in computer system 600 may include volatile memory and/or non-volatile memory. More specifically, memory 624 may include: ROM, RAM, EPROM, EEPROM, flash memory, one or more smart cards, one or more magnetic disc storage devices, and/or one or more optical storage devices. Memory 624 may store an operating system 626 that includes procedures (or a set of instructions) for handling various basic system services for performing hardware-dependent tasks. Memory 624 may also store procedures (or a set of instructions) in a communication module 628. These communication procedures may be used for communicating with one or more computers and/or servers, including computers and/or servers that are remotely located with respect to computer system 600.

Memory 624 may also include multiple program modules, including: social-network module 630, activity module 632, clipping module 634, and/or encryption module 636. Note that one or more of these program modules (or sets of instructions) may constitute a computer-program mechanism.

During operation of computer system 600, social-network module 630 facilitates interactions 638 among users 640 via communication module 628 and communication interface 612. These interactions may be tracked by activity module 632, and may include user posts, shares, likes, comments and so on. Then, clipping module 634 may provide, via communication module 628 and communication interface 612, instructions for clip-selection user interface 642, which allows a user to specify a clip selection (such as one of clip selections 644). In particular, based on the user's interaction with a clip-selection icon in clip-selection user interface 642, clipping module 634 may receive, via communication interface 612 and communication module 628, information specifying the clip selection. Note that the clip selection may specify a content item (such one of slides 648) in a sequential set of content items (such as presentation 646). Moreover, the clip selection may include a clipped-content identifier 650, with a pointer 652 to a location in memory 624 where the one of slides 648 is stored. In addition, the clip selection may include: metadata 654 associated with the one of slides 648, one or more annotations 656 associated with the one of slides 648, and/or a timestamp 658.

Furthermore, clipping module 634 may provide, via communication module 628 and communication interface 612, instructions for a clipped-content summary document 660 of clip selections 644. These clip selections may be organized in clipped-content summary document 660 based on: metadata 654 (such as names of the sequential set of content items that include clip selections 644, authors of the sequential set of content items that include clip selections 644, etc.).

In addition, clipped-content summary document 660 may include icons that allow the user to: download clip selections 644, edit the one or more annotations 656, share clip selections 644 with other users, and/or aggregate one or more clip selections 644 into new sequential sets of content items (such as presentation 662).

Because information in computer system 600 may be sensitive in nature, in some embodiments at least some of the data stored in memory 624 and/or at least some of the data communicated using communication module 628 is encrypted using encryption module 636.

Instructions in the various modules in memory 624 may be implemented in a high-level procedural language, an object-oriented programming language, and/or in an assembly or machine language. Note that the programming language may be compiled or interpreted, e.g., configurable or configured, to be executed by the one or more processors.

Although computer system 600 is illustrated as having a number of discrete items, FIG. 6 is intended to be a functional description of the various features that may be present in computer system 600 rather than a structural schematic of the embodiments described herein. In practice, and as recognized by those of ordinary skill in the art, the functions of computer system 600 may be distributed over a large number of servers or computers, with various groups of the servers or computers performing particular subsets of the functions. In some embodiments, some or all of the functionality of computer system 600 is implemented in one or more application-specific integrated circuits (ASICs) and/or one or more digital signal processors (DSPs).

Computer systems (such as computer system 600), as well as electronic devices, computers and servers in system 100 (FIG. 1), may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 112 (FIG. 1) may include: the Internet, World Wide Web (WWW), an intranet, a cellular-telephone network, LAN, WAN, MAN, or a combination of networks, or other technology enabling communication between computing systems.

System 100 (FIG. 1) and/or computer system 600 may include fewer components or additional components. Moreover, two or more components may be combined into a single component, and/or a position of one or more components may be changed. In some embodiments, the functionality of system 100 (FIG. 1) and/or computer system 600 may be implemented more in hardware and less in software, or less in hardware and more in software, as is known in the art.

Note that in some embodiments the content-management technique generates revenue via sponsored clip collections and/or payments to publish collections of clip selections. Moreover, the author or owner of a content item that is clipped may be paid for allowing other users to access their content items. In these ways, the content-management technique may expand the financial incentives of users and a provider of the content-management technique, which may increase engagement with and/or use of the content-management technique.

While a social network has been used as an illustration in the preceding embodiments, more generally the content-management technique may be used to view, aggregate and share content items in sequential sets of content items via a clipped-content identifier in a wide variety of applications or systems. Moreover, the content-management technique may be used in applications where the communication or interactions among different entities (such as people, organizations, etc.) can be described by a social graph. Note that the people may be loosely affiliated with a website (such as viewers or users of the website), and thus may include people who are not formally associated (as opposed to the users of a social network who have user accounts). Thus, the connections in the social graph may be defined less stringently than by explicit acceptance of requests by individuals to associate or establish connections with each other, such as people who have previously communicated with each other (or not) using a communication protocol, or people who have previously viewed each other's home pages (or not), etc. In this way, the content-management technique may be used to expand the quality of interactions and value-added services among relevant or potentially interested people in a more loosely defined group of people.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A computer-system-implemented method for providing a clipped-content summary document, the method comprising:
receiving a first clip selection of a content item in a sequential set of content items;
using the computer system, creating, in response to receiving the first clip selection, a first clipped-content identifier with a pointer to the content item in the sequential set of content items and metadata associated with the content item, wherein the pointer specifies a storage location in the computer system where the content item is stored; and
providing the clipped-content summary document of clip selections, including the first clip selection, wherein the first clip selection includes the first clipped-content identifier;
wherein the first clipped-content identifier associated with the first clip selection allows a user to access the content item without requiring that the content be extracted from the sequential set of content items.

2. The method of claim 1, wherein the clipped-content summary document includes a download icon and the method further comprises:
receiving activation information for the download icon, wherein the activation information specifies a given clip selection;
accessing a given content item associated with the given clip selection based on a given pointer to the given content item; and
providing the given content item.

3. The method of claim 1, wherein the clipped-content summary document includes an editing icon and the method further comprises:
receiving activation information for the editing icon, wherein the activation information specifies a given clip selection;
providing an annotation modification feature in the clipped-content summary document that allows a user to modify an annotation;
receiving a modification to the annotation; and
changing the annotation in given metadata associated with the given content item.

4. The method of claim 1, wherein the clipped-content summary document includes a sharing icon and the method further comprises:
receiving activation information for the sharing icon, wherein the activation information specifies a given clip selection;
providing a sharing-information feature in the clipped-content summary document that allows a user to share the given clip selection;
receiving contact information for another user; and
providing, based on the contact information, a given pointer and given metadata of the given clip selection.

5. The method of claim 1, wherein the clipped-content summary document includes an aggregation icon and the method further comprises:
receiving activation information for the aggregation icon;
providing an aggregation feature in the clipped-content summary document that allows a user to specify at least a subset of the clip selections;
aggregating pointers and metadata for at least the subset of the clip selection into another sequential set of content items; and
providing another pointer and other metadata for the other sequential set of content items in the clipped-content summary document.

6. The method of claim 1, wherein the metadata includes at least one of: a name of the sequential set of content items, one or more annotations associated with the content item, and an author of the sequential set of content items.

7. The method of claim 1, wherein the method further comprises:
providing information specifying a clip-selection user interface for display on an electronic device associated with a user; and
wherein the clip selection is associated with user activation of a clip-selection icon in the clip-selection user interface.

8. The method of claim 1, wherein the sequential set of content items includes one of: slides in a presentation, and frames in a video.

9. (canceled)

10. The method of claim 1, wherein the clip selection has an associated timestamp.

11. The method of claim 1, wherein the clip selections in the clipped-content summary document are organized by at least one of: metadata associated with the clip selections, names of the sequential set of content items that include the clip selections, and authors of the sequential set of content items that include the clip selections.

12. An apparatus, comprising:
one or more processors;
memory; and
a program module, wherein the program module is stored in the memory and, during operation of the apparatus, is executed by the one or more processors to provide a clipped-content summary document, the program module including:
instructions for receiving a first clip selection of a content item in a sequential set of content items;
instructions for creating, in response to receiving the first clip selection, a clipped-content identifier that includes a pointer to the content item in the sequential set of content items and metadata associated with the content item, wherein the pointer specifies a storage location in the computer system where the content item is stored; and
instructions for providing the clipped-content summary document of clip selections, including the first clip selection, wherein the first clip selection includes the first clipped-content identifier;
wherein the clipped-content identifier associated with the first clip selection allows a user to access the content item without requiring that the content be extracted from the sequential set of content items.

13. The apparatus of claim 12, wherein the clipped-content summary document includes a sharing icon and the program module further comprises:
instructions for receiving activation information for the sharing icon, wherein the activation information specifies a given clip selection;
instructions for providing a sharing-information feature in the clipped-content summary document that allows a user to share the given clip selection;
instructions for receiving contact information for another user; and
instructions for providing, based on the contact information, a given pointer and given metadata of the given clip selection.

14. The apparatus of claim 12, wherein the clipped-content summary document includes an aggregation icon and the program module further comprises:
instructions for receiving activation information for the aggregation icon;
instructions for providing an aggregation feature in the clipped-content summary document that allows a user to specify at least a subset of the clip selections;
instructions for aggregating pointers and metadata for at least the subset of the clip selection into another sequential set of content items; and
instructions for providing another pointer and other metadata for the other sequential set of content items in the clipped-content summary document.

15. The apparatus of claim 12, wherein the metadata includes at least one of: a name of the sequential set of content items, one or more annotations associated with the content item, and an author of the sequential set of content items.

16. The apparatus of claim 12, wherein the program module further includes:
instructions for providing information specifying a clip-selection user interface for display on an electronic device associated with a user; and
wherein the clip selection is associated with user activation of a clip-selection icon in the clip-selection user interface.

17. The apparatus of claim 12, wherein the sequential set of content items includes one of: slides in a presentation, and frames in a video.

18. (canceled)

19. The apparatus of claim 12, wherein the clip selections in the clipped-content summary document are organized by at least one of: metadata associated with the clip selections, names of the sequential set of content items that include the clip selections, and authors of the sequential set of content items that include the clip selections.

20. A system, comprising:
a processing module comprising a non-transitory computer-readable medium storing instructions that, when executed, cause the system to:
receive a first clip selection of a content item in a sequential set of content items;
create, in response to receiving the first clip selection, a clipped-content identifier that includes a pointer to the content item in the sequential set of content items and metadata associated with the content item, wherein the pointer specifies a storage location in the computer system where the content item is stored; and
provide a clipped-content summary document of clip selections, including the first clip selection, wherein the first clip selection includes the first clipped-content identifier;
wherein the clipped-content identifier associated with the first clip selection allows a user to access the content item without requiring that the content be extracted from the sequential set of content items.
